(19) United States
(12) Patent Application Publication
(10) Pub. No.: US 2008/0002256 A1
(43) Pub. Date: Jan. 3, 2008

(54) OPTICAL ARTICLE INCLUDING A BEADED LAYER

(75) Inventors: Itsuroh Sasagawa, Woodbury, MN (US); Wei Feng Zhang, Shanghai (CN); Yan Yan Zhang, Shanghai (CN); Hoon-Sung Jung, Yongin-City (KR); Byung-soo Ko, Seoul (KR); Ji-Hwa Lee, Suwon-city (KR); Wonho Lee, St. Paul, MN (US); Mark D. Gehlsen, Eagan, MN (US); Stephen J. Etzkorn, Woodbury, MN (US); Susan E. Anderson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/427,948

(22) Filed: Jun. 30, 2006

(51) Int. Cl. G02B 27/28

(52) U.S. Cl. 359/485; 359/483

(57) ABSTRACT

An optical article has a substrate including a reflective polarizing element preferentially reflecting light having a first polarization state and preferentially transmitting light having a second polarization state and a beaded layer disposed on the substrate. The beaded layer includes transparent binder and a plurality of transparent beads dispersed therein. A normal angle gain of the optical article with the beaded layer is increased when compared to a normal angle gain of the same optical article but without the beaded layer.

### FIELD OF THE INVENTION

The present disclosure is directed to optical articles that include a polarizing element and a beaded layer.

### BACKGROUND

Display devices, such as liquid crystal display (LCD) devices, are used in a variety of applications including, for example, televisions, hand-held devices, digital still cameras, video cameras, and computer monitors. Unlike a traditional cathode ray tube (CRT), an LCD panel is not self-illuminating and, therefore, sometimes requires a backlighting assembly or a “backlight.” A backlight typically couples light from one or more sources (e.g., a cold cathode fluorescent tube (CCFT) or light emitting diodes (LEDs)) to a substantially planar output. The substantially planar output is then coupled to the LCD panel.

The performance of an LCD is often judged by its brightness. Brightness of an LCD may be enhanced by using a larger number of light sources or brighter light sources. In large area displays it is often necessary to use a direct-lit type LCD backlight to maintain brightness, because the space available for light sources grows linearly with the perimeter while the illuminated area grows as the square of the perimeter. Therefore, LCD televisions typically use a direct-lit backlight instead of a light-guide edge-lit type LCD backlight. Additional light sources and/or a brighter light source may consume more energy, which is counter to the ability to decrease the power allocation to the display device. For portable devices this may correlate to decreased battery life. On the other hand, adding a light source to the display device may increase the product cost and weight and sometimes can lead to reduced reliability of the display device.

Brightness of an LCD may also be enhanced by efficiently utilizing the light that is available within the LCD device (e.g., to direct more of the available light within the display device along a preferred viewing axis). For example, Vikuiti™ Brightness Enhancement Film (BEF), available from 3M Company, has prismatic surface structures, which redirect some of the light exiting the backlight outside the viewing range to be substantially along the viewing axis. At least some of the remaining light is recycled via multiple reflections of some of the light between BEF and reflective components of the backlight, such as its back reflector. This results in optical gain substantially along the viewing axis and also results in improved spatial uniformity of the illumination of the LCD. Thus, BEF is advantageous, for example, because it enhances brightness and improves spatial uniformity. For a battery powered portable device, this may translate to longer running times or smaller battery size, and a display that provides a better viewing experience.

Another type of an optical element that may be used to increase brightness of a display is a reflective polarizer. Reflective polarizers typically reflect light of one polarization for a given wavelength range and substantially pass light of a different polarization. When reflective polarizers are used in conjunction with backlights in liquid crystal displays to enhance brightness of the display, a reflective polarizer can be placed between a backlight and a liquid crystal display panel. This arrangement permits light of one polarization to pass through to the display panel and light of the other polarization to recycle through the backlight or to reflect off a reflective surface positioned behind the backlight, giving the light an opportunity to depolarize and pass through the reflective polarizer.

One example of a polarizer includes a stack of polymer layers of differing compositions, such as Vikuiti™ Dual Brightness Enhancement Film (DBEF), available from 3M Company. One configuration, this stack of layers includes a first set of birefringent layers and a second set of layers with an isotropic index of refraction. The second set of layers alternates with the birefringent layers to form a series of interfaces for reflecting light. Another type of reflective polarizer includes continuous/disperse phase reflective polarizers that have a first material dispersed within a continuous second material that has an index of refraction for one polarization of light that is different than the corresponding index of the first material, such as Vikuiti™ Diffuse Reflective Polarizer Film (DRPF), available from 3M Company. Other types of reflective polarizer include other linear reflective polarizers, such as wire grid polarizers, and circular reflective polarizers, such as cholesteric liquid crystal polarizers.

### SUMMARY

In one implementation, the present disclosure is directed to an optical article having a substrate including a reflective polarizing element preferentially reflecting light having a first polarization state and preferentially transmitting light having a second polarization state and a beaded layer disposed on the substrate. The beaded layer includes transparent binder and a plurality of transparent beads dispersed therein. In this exemplary embodiment, the beads are present in an amount of about 100 to about 210 parts by weight per about 100 parts by weight of the binder and an average binder thickness over a linear inch is within about 60% of a median radius of the beads. The normal angle gain of the optical article with the beaded layer is increased when compared to a normal angle gain of the same optical article but without the beaded layer.

In another implementation, the present disclosure is directed to an optical article having a substrate including a reflective polarizing element preferentially reflecting light having a first polarization state and preferentially transmitting light having a second polarization state and a beaded layer disposed on the substrate. The beaded layer includes transparent binder and a plurality of transparent beads dispersed therein. In this exemplary embodiment, the beads are present in an amount of about 100 to about 210 parts by weight per about 100 parts by weight of the binder and a dry weight of the beaded layer is about 5 to about 50 g/m2. The normal angle gain of the optical article with the beaded layer is increased when compared to a gain of the same optical article but without the beaded layer.

In yet another implementation, the present disclosure is directed to an optical article including a substrate including a reflective polarizing element preferentially reflecting light having a first polarization state and preferentially transmitting light having a second polarization state and a beaded layer disposed on the substrate. The beaded layer includes transparent binder and a plurality of transparent beads dispersed therein. In this exemplary embodiment the beads are present in a volumetric amount of about 45 vol % to about 70 vol % of the coating and an average binder thickness over a linear inch is within about 60% of a median radius of the beads. The normal angle gain of the optical article with the beaded layer is increased when compared to a gain of the same optical article but without the beaded layer.

These and other aspects of the optical films and optical devices of the subject invention will become more readily apparent to those having ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1 is a schematic cross-sectional view of one embodiment of an optical film according to the invention,

FIG. 2 is a schematic cross-sectional view of a second embodiment of an optical film according to the invention;

FIG. 3 is a schematic cross-sectional view of a third embodiment of an optical film according to the invention;

FIG. 4 is a schematic cross-sectional view of a fourth embodiment of an optical film according to the invention; and

FIG. 5 is a schematic cross-sectional view of one embodiment of a backlit display according to the invention;

FIG. 6 is a graph illustrating the relationship between gain of an optical article according to the present disclosure and the beaded layer coating weight;

FIG. 7 is the graph of FIG. 6 along with the plot of a functional form approximating this functional relationship;

FIG. 8 is a graph illustrating the relationship between transmittance and haze of an optical article according to the present disclosure and the beaded layer coating weight;

FIG. 9 is a graph illustrating the relationship between voids area ratio % of an optical article according to the present disclosure and the beaded layer coating weight;

FIGS. 10A and 10B are micrographs of two samples of a beaded layer according to the present disclosure with 4.25% voids area ratio and 0.78% voids area ratio, respectively.

### DETAILED DESCRIPTION

The present invention is believed to be applicable to optical articles, which in some exemplary embodiments may be optical films, devices containing the optical articles, and methods of making and using the optical articles. The present invention is also directed to optical articles having at least one beaded layer and a reflective polarizing element, devices containing the optical articles, such as displays, and methods of making and using the optical articles. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

As used in connection with the present invention, “gain” refers to the ratio (a:b) of (a) the luminance of a backlight or display over a desired wavelength range at a particular viewing angle (with respect to a normal axis), to (b) the luminance of the same backlight or display over the desired wavelength range at the particular viewing angle (with respect to a normal axis) alone, i.e., without the optical article.

“Normal angle gain” refers to luminance gain at a viewing angle normal to the display, or at 90 degrees relative to a major plane or surface of the optical article.

“Contrast ratio” can be defined as follows. For a given viewing direction, a contrast ratio is defined as the ratio of the light intensity of the brightest white and the darkest black capable of being displayed on a screen. Typically, contrast ratio is measured for a specific location on a screen, with the display driven to brightest white and darkest black on separate occasions.

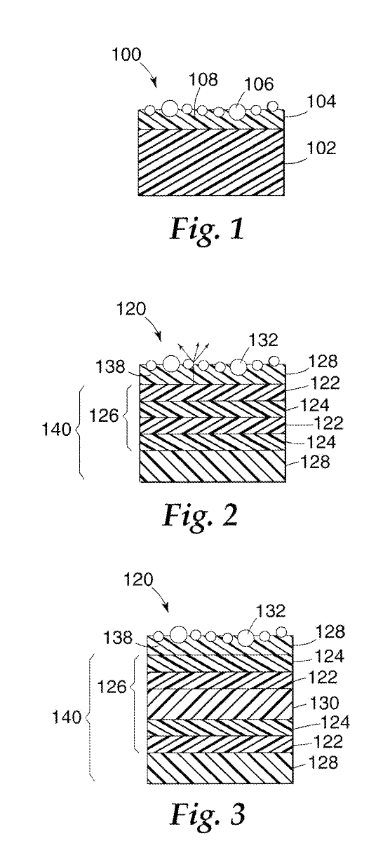

FIG. 1 illustrates schematically an optical article 100 including a substrate 102 including a reflective polarizing element and at least one beaded layer 104 containing beads 106 dispersed in a binder 108. The substrate can be a flexible film or a rigid plate. Beaded layer(s) can be disposed, for example, directly on a major surface of the reflective polarizing element or on an additional layer included into the substrate. Each beaded layer can be, for example, coated onto the reflective polarizing element, formed together (e.g., co-extruded) with the reflective polarizing element, or disposed on an additional layer attached to a reflective polarizing element, for example, using a suitable adhesive.

### Beaded Layer

It has been found that the addition of beads in a binder, which is in the optical path of light being polarized by the reflective polarizing element, provides some advantageous optical or mechanical properties. These properties include, for example, gain improvement, contrast improvement, reduction or elimination of wetting out and Newton's rings, diffusion, and color hiding or averaging. Preferably, the beads and binder have low birefringence and the beaded layer is polarization-preserving.

Typically, the beads contained in the beaded layer are solid articles that are substantially transparent and preferably transparent. They may be made of any suitable transparent material known to those of ordinary skill in the art, such as organic (e.g., polymeric) or inorganic materials. Some exemplary materials include, without limitation, inorganic materials, such as silica (e.g., Zeeospheres™, 3M Company, St. Paul, Minn.), sodium aluminosilicate, alumina, glass, talc, alloys of alumina and silica, and polymeric materials, such as liquid crystal polymers (e.g., Vectram™ liquid crystal polymer from Eastman Chemical Products, Inc., Kingsport, Tenn.), amorphous polystyrene, styrene acrylonitrile copolymer, cross-linked polystyrene particles or polystyrene copolymers, polydimethyl siloxane, crosslinked polydimethyl siloxane, polymethylsilsesquioxane and polymethyl methacrylate (PMMA), preferably crosslinked PMMA, or any suitable combinations of these materials. Other suitable materials include inorganic oxides and polymers that are substantially immiscible and do not cause deleterious reactions (degradation) in the material of the layer during processing of the particle-containing layers, are not thermally degraded at the processing temperatures, and do not substantially absorb light in the wavelength or wavelength range of interest.

The beads generally have a mean diameter in the range of, for example, 5 to 50 μm. Typically, the particles have a mean diameter in the range of 12 to 30 μm, or in some embodiments 12 to 25 μm. In at least some instances, smaller beads are preferred because this permits the addition of more beads per unit volume of the coating, often providing a rougher or more uniformly rough surface or more light diffusion centers. In some embodiments, the bead size distribution can be +/−50% and in other embodiments, it may be +/−40%. Other embodiments may include bead size distributions less than 40%, including a monodisperse distribution.

Although beads with any shape can be used, generally spherical beads are preferred in some instances, particularly for maximizing color hiding and gain. For surface diffusion, spherical particles give a large amount of surface relief per particle compared to other shapes, as non-spherical particles tend to align in the plane of the film so that the shortest principle axis of the particles is in the thickness direction of the film.

Typically, the binder of the beaded layer is also substantially transparent and preferably transparent. In most exemplary embodiments, the binder material is polymeric. Depending on the intended use, the binder may be an ionizing radiation curable (e.g., UV curable) polymeric material, thermoplastic polymeric material or an adhesive material. One exemplary UV curable binder may include urethane acrylate oligomer, e.g., Photomer™ 6010, available from Cognis Company.

The photopolymerizing prepolymers included in the ionizing radiation curable binders are incorporated in their structure with a functional group which is radical polymerized or cation polymerized by ionization radiation. The radical polymerized prepolymers are preferable because their hardening speed is high and enables to design the resin freely. Usable photopolymerizing prepolymers include acrylic prepolymers with acryoyl group such as urethane acrylate, epoxy acrylate, melamine acrylate, polyester acrylate, and the like.

Usable photo polymerizing monomers include single functional acrylic monomers such as 2-ethylhexyl acrylate, 2-hydroxyethyl acrylate, 2-hydroxypropyl acrylate, butoxypropyl acrylate and the like, two functional acrylic monomers such as 1,6-hexandiol acrylate, neopentylglycol diacrylate, diethyleneglycol diacrylate, polyethyleneglycol diacrylate, hydroxypivalate neopentylglycol acrylate and the like, and multifunctional acrylic monomers such as dipentaerythritol hexaacrylate trimethylpropane triacrylate, pentaerythritol triacrylate, and the like. These can be used individually or in combinations of two or more.

As a photo polymerization initiator, there can be used a radical polymerization initiator which induces cleavage, a radical polymerization initiator which pulls out hydrogen, or a cation polymerization initiator which generates ions. An initiator is selected from among the foregoing ones as proper for the prepolymer and the monomer. Usable radical photopolymerization initiators include benzoine ether system, ketal system, acetophenone system, tioxanthone system, and the like. Usable cation-type photopolymerization initiators include diazonium salts, diaryl iodonium salts, triaryl sulfonium salts, triaryl pyrilium salts, benzine pyridinium tiocyanate, dialkyl phenancyl sulfonium salts, dialkyl hydroxy phenylphosphonium salts, and the like. These radical type photopolymerization initiators and cation type photopolymerization initiators can be used alone or as a mixture thereof. The photopolymerization intiator is required for the ultraviolet (UV) radiation curable resins but can be omitted for the high-energy electron beam radiation curable resins.

The ionizing radiation curable resin may include intensifiers, pigments, fillers, non-reactive resin, leveling agents and the like as occasion demands, besides the photopolymerizing prepolymer, the photopolymerizing monomer and the photopolymerization initiator.

The ionizing radiation curable resin is included preferably in an amount of not less than 25% by weight of the binder resin of the beaded layer, more preferably not less than 50% by weight and most preferably not less than 75% by weight.

As the binder of the beaded layer, thermosetting resins such as thermosetting urethane resins consisting of acrylic polyol and isocyanate prepolymer, phenol resins, epoxy resins, unsaturated polyester resins or the like, and thermoplastic resins such as polycarbonates, thermoplastic acrylic resins, ethylene vinyl acetate copolymer resins or the like may be included in addition to the ionizing radiation curable resin. However, the content of the thermosetting resins and the thermoplastic resins is preferably within 75% by weight based on the total binder volume of the beaded layer so that they do not hamper occurrence of surface undulations in the ionizing radiation curable resin.

In some embodiments, the binder is flexible when cured, such that the optical article of the present disclosure is a flexible film that can be rolled.

The amount of beads in the beaded layer typically depends on factors such as, for example, the desired properties of the optical film, the type and composition of the polymer used for the binder layer, the type and composition of the beads, and the index difference between the beads and the binder. The beads can be provided in the beaded layer in amounts of, for example, at least 100 to 210 parts by weight to 100 parts by weight of the binder. In some exemplary embodiments of the present disclosure, beads can be provided in the beaded layer in amounts of, for example, at least 120 parts by weight to 100 parts by weight of the binder, at least 155 parts by weight to 100 parts by weight of the binder, at least 170 parts by weight to 100 parts by weight of the binder, or at least 180 parts by weight to 100 parts by weight of the binder. Smaller amounts may not have a significant effect on film properties, while larger amounts, e.g., more than 210 parts by weight are expected to reduce the gain of the optical article. In the latter case, the gain reduction is believed to be due to stacking of the beads.

The beads may be provided in a volumetric amount of 45 vol % to 70 vol % of the coating. In some exemplary embodiments of the present disclosure, beads may be provided in the beaded layer in volumetric amounts of, for example, 52 vol % to 70 vol %, 58 vol % to 70 vol %, 60 vol % to 70 vol %, or 62 vol % to 70 vol %. Depending on the application, the volumetric amount of the beads in the beaded layer may be measured before the coating is dried and cured, or it may be measured after the coating has been dried and cured.

In some exemplary embodiments, the refractive index difference between the beads and the binder is in the range of, for example, 0 to 0.12. To obtain diffusing (e.g., scattering) effects, the beads can have an index of refraction different than the index of refraction of the binger (bulk diffusion). Alternatively, the index of the particles can be matched to the index of refraction of the binder, in which case the rough surface alone supplies the required diffusion (surface diffusion) or gain improvement. In some instances, it may be preferred that the beads have an index of refraction that is substantially similar to the index of refraction of the binder. For example, the index difference between the beads and binder can be about 0.2 or less, about 0.1 or less, preferably about 0.05 or less, and more preferably about 0.01 or less.

The difference in the indices of refraction of the beads and the binder can influence factors such as, for example, the normal angle gain (a measure of the amount of increased brightness obtained using the optical film in a backlit display configuration) of the optical article and the amount of color averaging obtained by scattering. Generally, normal angle gain decreases with increased difference between the indices of refraction of the beads and the binder. In contrast, the amount of color averaging increases with increased difference between the indices of refraction of the beads and the binder because larger index differences lead to higher scattering. Thus, the beads and the materials of the binder can be selected, based at least in part on their indices of refraction, to achieve a desired balance of these properties.

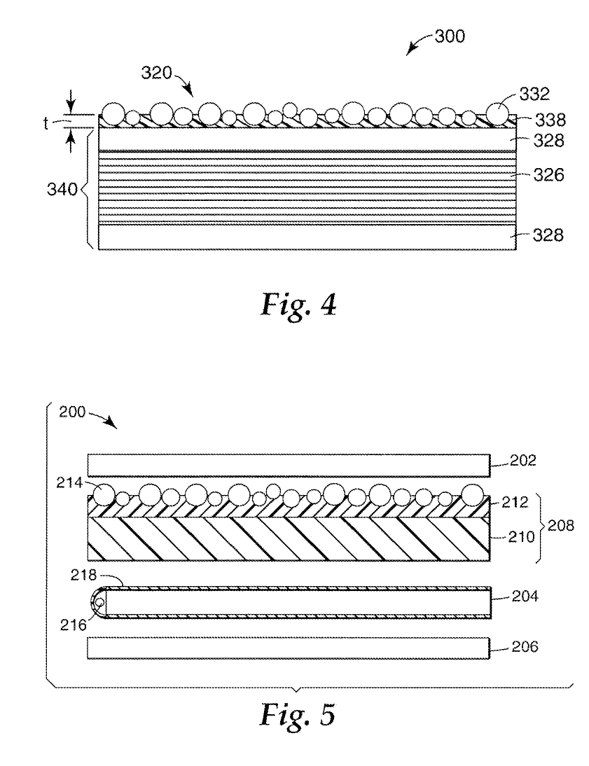

The beaded layer can be characterized in terms of how the average binder thickness relates to a median radius of the beads. This concept may be illustrated with reference to FIG. 4, which shows an optical article 300, including a beaded layer 320, including beads 332 and binder 338, and a substrate 340 including a reflective polarizing element 326. Binder thickness is shown in FIG. 4 as “t”. It is believed that when the dried and cured binder thickness does not depart too far from the median radius of the beads, the optical article will have improved gain over the same optical article without the beaded layer. For example, it is believed that advantageous performance may be achieved where an average binder thickness over a linear inch on a major surface of an optical article (such as an optical film) is within 60%, 40% or 20% of a median radius of the beads. In other exemplary embodiments, the average binder thickness over two linear inches is within 60%, 40% or 20% of a median radius of the beads.

Dry binder thickness can be measured by making a cross-section of an exemplary optical article, taking at least 10 measurements over an inch (or two inches) of a sample using any suitable microscopic techniques and equipment, and averaging the measurements made to produce a dry average binder thickness value. Alternatively, dry binder thickness can be measured using any suitable thickness meter to measure the thickness of total film and subtracting the thickness of uncoated film.

In addition, the beaded layer can be characterized based on the percent to which the beads occupy the surface of the beaded layer. Increasing the amount of exposed surface area of the beaded layer that is occupied by the beads provides additional advantages in luminance gain of, for example, a backlight or optical display including a reflective polarizing element with particles in a binder. Where gain is to be increased, however, the surface including beads preferably faces away from the light source and the beads preferably occupy at least a majority or more (i.e., 50% or more) of the exposed useful surface area of the beaded layer, more preferably about 60% or more, still more preferably about 70% or more, and even more preferably about 90% or more.

The beaded layer also can be characterized in terms of coating weight. It is believed that when the dried and cured coating weight falls within a desired range, the optical article will have improved gain over the same optical article without the beaded layer. This or other advantageous purposes may be accomplished by adjusting the bead to binder ratio of the beaded layer composition and/or disposing the beaded layer mixture on a substrate, such that the beaded layer mixture has a dry weight of 5 to 50 g/m2. In other exemplary embodiments, the beaded layer mixture disposed on a substrate may have a dry weight of 10 to 35 g/m2, 15 to 30 g/m2, or 20 to 25 g/m2.

A monolayer distribution of particles in a surface layer on a reflective polarizing element can also increase gain at the normal axis. In addition, monolayer distribution can also reduce or eliminate visible off-axis color non-uniformities for multilayer optical film reflective polarizers. The gain using an optical article of the present disclosure with a beaded layer disposed such that light is incident on the surface of the substrate opposite the beaded layer is improved as compared to the same optical article without the beaded layer. Preferably, the gain is improved by 5% or more, more preferably, by 7% or more, by 8% or more and even more preferably, by 9% or more for a wavelength (e.g., 632.8 nm) or wavelength range of interest. In some exemplary embodiment, the gain is improved by 10% or more or even 11% or more. Here, the % improvement is calculated as the difference between the gain of the optical article with the beaded layer and the gain of the same optical article but without the beaded layer divided by the gain of the optical article without the beaded layer.

Optical articles according to the present disclosure can also have a contrast ratio improvement as compared to the same optical article without the beaded later. The contrast ratio of the optical article including a beaded layer may be improved by 10% or more, 20% or more, or sometimes 30% or more as compared to the same optical article without a beaded layer.

Preferably, the beads do not substantially absorb or depolarize light transmitted by the reflective polarizing element. Preferably, the amount of light transmitted through the optical article is not substantially reduced. More preferably the amount of light having the polarization preferentially transmitted by the reflective polarizing element is not substantially reduced, as determined using, for example, a second polarizer.

### Reflective Polarizing Elements

Any type of reflective polarizing elements can be used in the optical articles of the present disclosure. Typically, the reflective polarizing elements preferentially transmit light of one polarization state and preferentially reflect light of a different polarization state. More typically, the reflective polarizing elements substantially transmit light of one polarization state and substantially reflect light of a different polarization state. The materials and structures used to accomplish these functions can vary. Depending on the materials and structure of the optical film, the term “polarization state” can refer to, for example, linear, circular, and elliptical polarization states.

Examples of suitable reflective polarizing elements include, without limitation, multilayer reflective polarizers, continuous/disperse phase reflective polarizers, cholesteric reflective polarizers (which are optionally combined with a quarter wave plate), and wire grid polarizers. In general, multilayer reflective polarizers and cholesteric reflective polarizers are specular reflectors and continuous/disperse phase reflective polarizers are diffuse reflectors, although these characterizations are not universal (see, e.g., the diffuse multilayer reflective polarizers described in U.S. Pat. No. 5,867,316). This list of illustrative reflective polarizing elements is not meant to be an exhaustive list of suitable reflective polarizing elements. Any reflective polarizer that preferentially transmits light having one polarization and preferentially reflects light having a second polarization can be used.

Both multilayer reflective polarizers and continuous/disperse phase reflective polarizers rely on index of refraction differences between at least two different materials (preferably polymers) to selectively reflect light of one polarization orientation while transmitting light with an orthogonal polarization orientation. Suitable diffuse reflective polarizers include the continuous/disperse phase reflective polarizers described in U.S. Pat. No. 5,825,543, incorporated herein by reference, as well as the diffusely reflecting multilayer polarizers described in U.S. Pat. No. 5,867,316, incorporated herein by reference. Other reflective polarizing elements are described in U.S. Pat. No. 5,751,388, incorporated herein by reference.

Cholesteric reflective polarizers are described in, e.g., U.S. Pat. No. 5,793,456, U.S. Pat. No. 5,506,704, and U.S. Pat. No. 5,691,789, all of which are incorporated herein by reference. One cholesteric reflective polarizer is marketed under the trademark TRANSMAX™ by E. Merck & Co. Wire grid polarizers are described in, for example, PCT Publication WO 94/11766, incorporated herein by reference.

Illustrative multilayer reflective polarizers are described in, for example, U.S. Pat. No. 5,882,774 to Jonza et al., PCT Publication Nos. WO95/17303; WO95/17691; WO95/17692; WO95/17699; WO96/19347; and WO99/36262, all of which are incorporated herein by reference. One commercially available form of a multilayer reflective polarizer is marketed as Dual Brightness Enhanced Film (DBEF) by 3M Company, St. Paul, Minn. Multilayer reflective polarizers are used herein as an example to illustrate optical film structures and methods of making and using the optical films of the invention. The structures, methods, and techniques described herein can be adapted and applied to other types of suitable reflective polarizing elements.

A suitable multilayer reflective polarizer for an optical film can be made by alternating (e.g., interleaving) uniaxially- or biaxially-oriented birefringent first optical layers with second optical layers. In some embodiments, the second optical layers have an isotropic index of refraction that is approximately equal to one of the in-plane indices of the oriented layer. Alternatively, both optical layers are formed from birefringent polymers and are oriented so that the indices of refraction in a single in-plane direction are approximately equal. Whether the second optical layers are isotropic or birefringent, the interface between the first and second optical layers forms a light reflection plane. Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers.

Typically, the highest reflectivity for a particular interface occurs at a wavelength corresponding to twice the combined optical thickness of the pair of optical layers, which form the interface. The optical thickness describes the difference in path length between light rays reflected from the lower and upper surfaces of the pair of optical layers. For light incident at 90 degrees to the plane of the optical film (normally incident light), the optical thickness of the two layers is n1 d1+n2 d2, where n1, n2 are the indices of refraction of the two layers and d1, d2 are the thicknesses of the corresponding layers. This equation can be used to tune the optical layers for normally incident light using only a single out-of-plane (e.g., nz) index of refraction for each layer. At other angles, the optical distance depends on the distance traveled through the layers (which is larger than the thickness of the layers) and the indices of refraction in at least two of the three optical axes of the layer. Typically, the transmission of light incident on the optical film at an angle less than 90 degrees with respect to the plane of the film produces a spectrum with a bandedge that is shifted to a lower wavelength (e.g., blue-shifted) relative to the bandedge observed for transmission of normally incident light.

With respect to normally incident light, the optical layers can each be a quarter wavelength thick or the optical layers can have different optical thicknesses, so long as the sum of the optical thicknesses is half of a wavelength (or a multiple thereof). A film having a plurality of layers can include layers with different optical thicknesses to increase the reflectivity of the film over a range of wavelengths. For example, a film can include pairs of layers which are individually tuned (for normally incident light, for example) to achieve optimal reflection of light having particular wavelengths.

The first optical layers are preferably birefringent polymer layers that are uniaxially- or biaxially-oriented. The second optical layers can be polymer layers that are birefringent and uniaxially- or biaxially-oriented or the second optical layers can have an isotropic index of refraction which is different from at least one of the indices of refraction of the first optical layers after orientation.

The first optical layers are typically orientable polymer films, such as polyester films, which can be made birefringent by, for example, stretching the first optical layers in a desired direction or directions. The term “birefringent” means that the indices of refraction in orthogonal x, y, and z directions are not all the same. For films or layers in a film, a convenient choice of x, y, and z axes includes the x and y axes corresponding to the length and width of the film or layer and the z axis corresponding to the thickness of the layer or film.

The first optical layers, can be uniaxially-oriented, for example, by stretching in a single direction. A second orthogonal direction can be allowed to neck (e.g., decrease in dimension) into some value less than its original length. A birefringent, uniaxially-oriented layer typically exhibits a difference between the transmission or reflection of incident light rays having a plane of polarization parallel to the oriented direction (i.e., stretch direction) and light rays having a plane of polarization parallel to a transverse direction (i.e., a direction orthogonal to the stretch direction). For example, when an orientable polyester film is stretched along the x axis, the typical result is that nx≠ny, where nx and ny are the indices of refraction for light polarized in a plane parallel to the “x” and “y” axes, respectively. The degree of alteration in the index of refraction along the stretch direction depends on factors such as, for example, the amount of stretching, the stretch rate, the temperature of the film during stretching, the thickness of the film, the thickness of the individual layers, and the composition of the film. Typically, the first optical layers have an in-plane birefringence (the absolute value of nx−ny) after orientation of 0.04 or greater at 632.8 nm, preferably about 0.1 or greater, and more preferably about 0.2 or greater. All birefringence and index of refraction values are reported for 632.8 nm light unless otherwise indicated.

In some embodiments, the second optical layers are uniaxially or biaxially orientable. In other embodiments, the second optical layers are not oriented under the processing conditions used to orient the first optical layers. These second optical layers substantially retain a relatively isotropic index of refraction, even when stretched or otherwise oriented. For example, the second optical layers can have a birefringence of about 0.06 or less, or about 0.04 or less, at 632.8 nm.

The first and second optical layers are generally no more than 1 μm thick and typically no more than 400 nm thick, although thicker layers can be used, if desired. These optical layers can have the same or different thicknesses.

The first and second optical layers and, in some embodiments, optional non-optical layers of a multilayer reflective polarizer are typically composed of polymers such as, for example, polyesters, copolyesters and modified copolyesters. Other types of reflective polarizing elements (e.g., continuous/disperse phase reflective polarizers, cholesteric polarizers, and wire grid polarizers) can be formed using the materials described in the references cited above. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers.

Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 2,2′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis(2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

A second polymer of the second optical layers should be chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,762 and 6,498,683 and U.S. patent application Ser. Nos. 09/229,724, 09/232,332, 09/399,531, and 09/444,756, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to the isotropic refractive index of the first polymer. Examples of other polymers suitable for use in optical films and, particularly, in the second optical layers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly(methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other suitable polymers, especially for use in the second optical layers, include polyolefin copolymers such as poly(ethylene-co-octene) (PE-PO) available from Dow-Dupont Elastomers under the trade designation Engage 8200, poly(propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M. PMMA refers to polymethyl methacrylate and PETG refers to a copolymer of PET employing a second glycol (usually cyclohexanedimethanol). sPS refers to syndiotactic polystyrene.

FIG. 2 illustrates schematically another exemplary optical article 120 including a substrate 140 including a reflective polarizing element 126 and at least one beaded layer 128 containing beads 132 dispersed in a binder 138. The exemplary reflective polarizing element 126 is a multilayer reflective polarizer that includes alternating first optical layers 122 and second optical layers 124. In addition to the first and second optical layers 122, 124, the optical article 120 optionally includes one or more additional layers such as, for example, one or more outer layers 128 (or 328 in FIG. 4) or one or more interior layers 130, as illustrated in FIG. 3. Additional sets of optical layers, similar to the first and second optical layers 122, 124 can also be used in a multilayer reflective polarizer. The design principles disclosed herein for the sets of first and second optical layers can be applied to any additional sets of optical layers. Furthermore, it will be appreciated that, although only a single multilayer stack 126 is illustrated in FIGS. 2 and 3, the multilayer reflective polarizer can be made from multiple stacks that are combined to form the film.

Furthermore, although FIGS. 2-3 show only four optical layers 122, 124, multilayer reflective polarizers 126 can have a large number of optical layers. Generally, multilayer reflective polarizers have about 2 to 5000 optical layers, typically about 25 to 2000 optical layers, and often about 50 to 1500 optical layers or about 75 to 1000 optical layers.

As illustrated in FIGS. 2 and 3, the beaded layer 128 containing beads 132 and binder 138 can be disposed directly on the reflective polarizing element 126. In other exemplary embodiments, illustrated in FIG. 4, the beaded layer 320 may be disposed on an additional layer 328. In some exemplary embodiments, one or more additional layers may be disposed between the beaded layer and the reflective polarizing layer. In other exemplary embodiments, one or more additional layers may be disposed on a side of the substrate that is disposed opposite the beaded layer. In such exemplary embodiments, the reflective polarizing element is disposed between the beaded layer and the additional layer(s). In yet other exemplary embodiments, additional layers may be disposed both (i) between the beaded layer and the reflective polarizing layer and (ii) on a side of the substrate that is disposed opposite the beaded layer. The examples shown in FIGS. 2 to 4 can be modified for use with other reflective polarizing elements, such as, for example, continuous/disperse phase reflective polarizers, cholesteric reflective polarizers, and wire grid reflective polarizers.

### Additional Layers

Additional layers may be used in multilayer reflective polarizers to, for example, give the polarizer structure or protect the polarizer from harm or damage during or after processing. In some exemplary embodiments, additional layers are or include skin layers disposed to form a major surface of the multilayer reflective polarizer and interior layers disposed between packets of optical layers. Coatings may also be considered additional layers. In some exemplary embodiments, the additional layers typically do not substantially affect the polarizing properties of the optical films over the wavelength region of interest (e.g., visible light). Suitable polymer materials for the additional layers of multilayer reflective polarizers (and other reflective polarizing elements) can be the same as those used for the first or second optical layers.

The optional additional layers can be thicker than, thinner than, or the same thickness as the first and second optical layers. The thickness of the additional layers may be at least four times, typically at least 10 times, and can be at least 100 times, the thickness of at least one of the individual first and second optical layers. In some exemplary embodiments, a thick additional layer may be a rigid plate. The thickness of the additional layers can be varied to make a substrate having a particular thickness.

Typically, one or more of the additional layers are placed so that at least a portion of the light to be transmitted, polarized, or reflected by the reflective polarizing element also travels through these layers (i.e., these layers are placed in the path of light which travels through or is reflected by the first and second optical layers). Exemplary embodiments of the present disclosure can have one or more of the additional layers that have low birefringence or high birefringence and/or one or more additional layers that are isotropic. In some exemplary embodiments, the substrate may include one or more adhesive layers, polycarbonate layers, poly methyl methacrylate layers, polyethylene terephthalate layers or any other suitable films or materials known to those of ordinary skill in the art.

One or more additional layers included into some exemplary articles of the present disclosure can be optical films. The additional optical films may be any suitable films known to those of ordinary skill in the art and the particular type will depend on the application. For example, an optical article according to the present disclosure may include a structured surface film disposed at the surface of the substrate opposite the beaded layer. Alternatively or additionally, an optical article according to the present disclosure may include a structured surface film disposed adjacent the beaded layer. The structured surface may be disposed facing the substrate or it may be disposed facing away from the substrate. Exemplary structured surface films suitable for use with embodiments of the present disclosure include, without limitation, structured surface films having a plurality of linear prismatic structures, such as BEF, structured surface films having a plurality of grooves, structured surface films including matrix arrays of surface structures and any other structured surface films.

Various other functional layers or coatings may be added to the films or articles of the present invention to alter or improve their physical or chemical properties, particularly along the surface of the film or article. A particle-containing layer may be used to roughen the surface of the substrate opposite to the surface having the beaded layer. In other embodiments, the surface of the substrate disposed opposite to the surface having the beaded layer may be made rough by other means. Exemplary layers or coatings suitable for use in embodiments of the present disclosure may include, for example, low adhesion backside materials, conductive layers, antistatic coatings or films, barrier layers, flame retardants, UV stabilizers, abrasion resistant materials, matte or diffuse coatings or layers, other optical coatings, and substrates designed to improve the mechanical integrity or strength of the film or device.

One or more additional layers may be laminated together with the optical article, coated onto a component of the optical article or otherwise attached to the optical article having the beaded layer. Alternatively or additionally, one or more additional layers may be simply stacked with an optical article according to the present disclosure. Where one or more additional layers are attached to the substrate or to the reflective polarizing element, such one or more layers are considered comprised in the substrate. Where an additional layer is disposed adjacent to and in contact with the beaded layer, the additional layer is considered comprised in the optical article.

### Display Examples

The optical films can be used in a variety of display systems and other applications, including transmissive (e.g., backlit), reflective, and transflective displays. For example, FIG. 5 illustrates a cross-sectional view of one illustrative backlit display system 200 according to the present invention including a display medium 202, a backlight 204, a polarizer 208, and an optional reflector 206. A viewer is located on the side of the display device 202 that is opposite from the backlight 204. The display medium 202 displays information or images to the viewer by transmitting light that is emitted from the backlight 204. One example of a display medium 202 is a liquid crystal display (LCD) that transmits only light of one polarization state. Because an LCD display medium is polarization-sensitive, it may be preferred that the backlight 204 supply light with a polarization state that is transmitted by the display device 202.

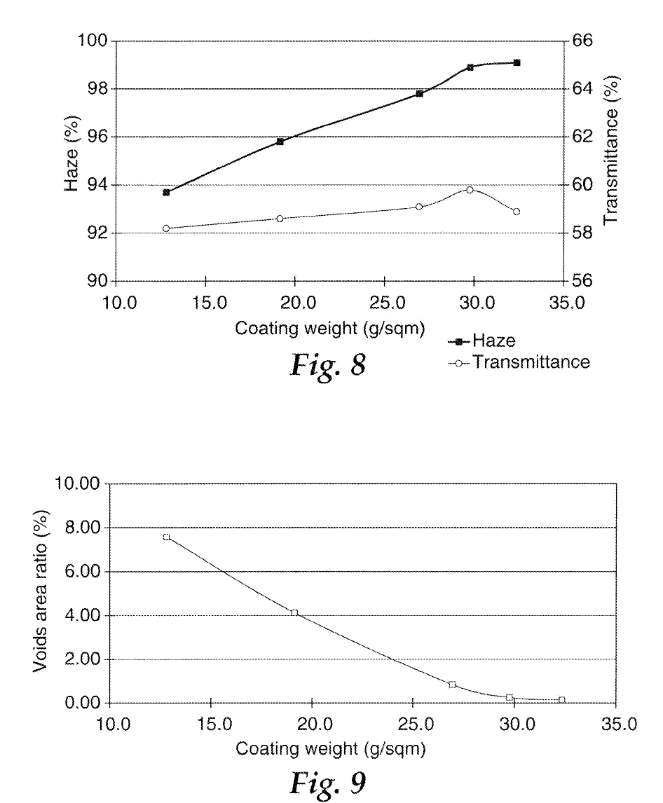

The backlight 204 that supplies the light used to view the display system 200 includes a light source 216 and a light guide 218. Although the light guide 218 depicted in FIG. 8 has a generally rectangular cross-section, backlights can use light guides with any suitable shape. For example, the light guide 218 can be wedge-shaped, channeled, a pseudo-wedge guide, etc. In some exemplary embodiments, the backlight includes a lightguide and light sources disposed on one, two or more sides of the lightguide, such as CCFTs or arrays of LEDs. In other exemplary embodiments, the backlight may be a direct-lit type, and it may include an extended light source disposed on the side of the display that is opposite to the viewer, which may be a surface emission-type light source. In yet other exemplary embodiments, a direct-lit type backlight may include one, two, three or more light sources, such as CCFTs or arrays of LEDs, disposed on the side of the display that is opposite to the viewer.

The optical article 208 is an optical film that includes a reflective polarizing element 210 and at least one beaded layer 212 containing beads 214 and a binder. The optical article 208 is provided as a part of the backlight to substantially transmit light of one polarization state exiting the light guide 218 and substantially reflect light of a different polarization state exiting the light guide 218. The reflective polarizing element 208 can be, for example, a multilayer reflective polarizer, a continuous/disperse phase reflective polarizer, a cholesteric reflective polarizer, or a wire grid reflective polarizer. Although the beaded layer 212 is illustrated as being on the reflective polarizing element, the beaded layer can be disposed, for example, on the reflective polarizing element, as described above.

In one embodiment, the beaded layer 212 is utilized for its gain improving properties. In this embodiment, the beaded layer is preferably an outer layer or coating on a substrate including a reflective polarizing element 210 or directly on a surface of the reflective polarizing element 210 opposite the surface that receives light from the backlight 204.

The optical article can also be used with an absorbing polarizer or with an absorbing polarizer layer, as described, for example, in U.S. Pat. No. 6,096,375 to Ouderkirk et al., WO 95/17691, WO 99/36813, and WO 99/36814, all of which are herein incorporated by reference. In this embodiment, the beaded layer can hide color as described above. The addition of a particle-containing layer typically reduces color leakage in such configurations.

Generally, the backlight display system can include any other suitable film. For example, one or more structured surface films, such as BEF, can be included into the display. An exemplary embodiment of a backlight display system may include a backlight, an optical article according to the present disclosure, a display medium and one or more structured surface films disposed between the optical article and the display medium. Other suitable additional films may include beaded diffuser films including a transparent substrate and a diffuser layer disposed thereon, the diffuser layer including beads or particles disposed in a binder. Suitable beaded diffusers are described in U.S. Pat. Nos. 5,903,391, 6,602,596, 6,771,335, 5,607,764 and 5,706,134, the disclosures of which are hereby incorporated by reference herein to the extent they are not inconsistent with the present disclosure. One exemplary embodiment of a backlight display system may include a backlight, an optical article according to the present disclosure, a display medium and one, two, three or more beaded diffuser films disposed between the optical article and the display medium.

### Methods of Making Optical Articles

The beads can be added to the beaded layer or layers using a variety of methods. For example, the beads can be combined with the polymer of the binder in an extruder. The beaded layer(s) can then be coextruded with the optical layers to form the optical article, which in this case is an optical film. Alternatively, the beads can be combined with the polymer of the binder in other ways including, for example, mixing the particles and polymer in a mixer or other device prior to extrusion.

In one method, the beads may be mixed with the polymer of the binder, photoinitiator, and a solvent to form an ionizing radiation curable mixture for the beaded layer. Optional additives may be added to the mixture, including without limitation, stabilizers, UV absorbers, antioxidants, anti-settling agents, dispersants, wetting agents, optical brighteners and antistatic agents.

Alternatively, the beads can be added to the monomers used to form the polymer of the binder. For example, with polyester binder, the beads might be added in the reaction mixture containing the carboxylate and glycol monomers used to form the polyester. Preferably, the beads do not affect the polymerization process or rate by, for example, catalyzing degradation reactions, chain termination, or reacting with the monomers. Zeeospheres™ are one example of a suitable bead for addition to monomers used to form polyester particle-containing layers. Preferably, the beads do not include acidic groups or phosphorus if they are combined with the monomers used to make the polyester.

In some instances, a master batch is prepared from beads and polymer using any of the methods known to those skilled in the art. This master batch can then be added, in selected proportions, to additional polymer in an extruder or mixer to prepare a film with a desired amount of beads.

In an exemplary method of providing a beaded surface layer, a surface layer precursor can be deposited on a previously formed reflective polarizing element. The surface layer precursor can be any material suitable for forming a coating on the reflective polarizing element, including monomer, oligomer, and polymer materials. For example, the surface layer precursor can be any of the polymer described above for use in the first and second optical layer and the non-optical layers or precursors of those polymers, as well as materials such as sulfopolyurethanes, sulfopolyesters, fluoroacrylates, and acrylates.

In such exemplary embodiments, the beads can be provided in a premixed slurry, solution, or dispersion with the surface layer precursor. As an alternative, the beads can be provided separately from the surface layer precursor. For example, if the precursor is coated on the reflective polarizing element first, the beads can be deposited on the precursor, e.g., by dropping, sprinkling, cascading, or otherwise disposed, to achieve a desired monolayer or other distribution of the beads in and/or on the surface layer. The precursor can then be cured, dried or otherwise processed to form the desired surface layer that retains the beads in a manner as desired. The relative proportions of the surface layer precursor and the beads can vary based on a variety of factors including, for example, the desired morphology of the resulting roughened surface layer and the nature of the precursor.

In another exemplary method of providing a beaded layer, the substrate or the reflective polarizing element itself may be primed for improving adhesion. Exemplary priming techniques include chemical priming, corona surface treatment, flame surface treatment, flashlamp treatment and others. The mixture may then be coated onto the treated surface using typical solvent coaters, dried, for example, by air drying, and solidified. The solidification of the beaded layer may sometimes be performed by UV curing. Once the beaded layer solidifies, the optical article may be laminated to additional layers. However, in other embodiments, additional layers may be added at different times, e.g., before the beaded layer is disposed on the substrate or during coextruson.

Those of ordinary skill in the art will readily appreciate that these methods are merely exemplary and any suitable number and combination of the steps described above may be performed in any suitable order to make exemplary embodiments of the present disclosure. Where needed, additional steps may be used.

### EXAMPLES

The present disclosure will be further illustrated with reference to the following examples representing properties of some exemplary optical films constructed according to the present disclosure.

### Example 1

### Raw Materials for the Beaded Layer Mixture:

TABLE 1

| Component | Description | Trade Name | Company |
|---|---|---|---|
| Beads | copolymer of methyl methacrylate | MBX-20 | Sekisui |
| | and ethyleneglycol dimethacrylate | | Chemical |
| Binder | aliphatic urethane acrylate oligomer | Photomer 6010 | Cognis |
| Additives | copolyacrylate leveling agent | Perenol F-45 | Cognis |
| Additives | liquid rheological additive (solution of | BYK 411 | BYK Chemie |
| | a modified urea) | | |
| Initiator | polymeric hydroxy ketone | Esacure One | Lamberti |
| Solvent | isopropyl alcohol | IPA | |
| Substrate | PEN/coPEN multilayer reflective | DBEF | 3M |
| | polarizer with coPEN outer layers | | |

### The reflective polarizer (RP) used as a substrate in Example 1 was a PEN/coPEN multilayer reflective polarizer with coPEN outer layers and without skin layers.

### Formulation of the beaded layer mixture is shown in Table 2:

TABLE 2

| | Weight | | Volume |
|---|---|---|---|
| | Parts | Density | Parts |
| Binder | 100.0 | 1.08 | 92.6 |
| Initiator | 4.0 | 1.12 | 3.6 |
| Additive 1 (F45) | 2.0 | 0.94 | 2.1 |
| Additive 2 (BYK411) | 2.0 | 1.1 | 1.8 |
| Beads | 183.9 | 1.2 | 153.2 |
| IPA | 356.8 | 0.787 | 453.3 |

| | wt % | | vol % |
|---|---|---|---|
| Bead Loading | 63.0% | ---> | 60.5% |
| Solid | 45.0% | ---> | 35.9% |

The beaded layer mixture of Table 2 was coated onto the substrate using a slot type die syringe pump. The coating width was 4″ and the substrate web was propelled at the speed of 15 fpm. Coating weight was controlled by controlling the amount of material expelled from the syringe pump, characterized as flow rate. Five different samples (1-5) were thus prepared with different coating weights resulting in different average thickness values of the binder.

The coating weight was determined by direct measurement. Weight of a sample with a beaded layer was compared to weight of the substrate of the same size and from the same lot. The coating weight measurement was made for the dried and cured coating.

### Gain Measurement

The general relative gain test method used to quantify the optical performance of the inventive optical articles is now described. Although specific details are given for completeness, it should be readily recognized that similar results can be obtained using modifications of the following approach using other commercially available equipment. Optical performance of the films was measured using a SpectraScan™ PR-650 SpectraColorimeter with an MS-75 lens, available from Photo Research, Inc, Chatsworth, Calif. The optical articles were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of ˜6 mm thickness. One face of the box is chosen as the sample surface. The hollow light box had a diffuse reflectance of ˜0.83 measured at the sample surface (e.g. ˜83%, averaged over the 400-700 nm wavelength range, box reflectance measurement method described further below). During the gain test, the box is illuminated from within through a ˜1 cm circular hole in the bottom of the box (opposite the sample surface, with the light directed towards the sample surface from the inside). This illumination is provided using a stabilized broadband incandescent light source attached to a fiber-optic bundle used to direct the light (Fostec DCR-II with ˜1 cm diam. fiber bundle extension from Schott-Fostec LLC, Marlborough Mass. and Auburn, N.Y.). A standard linear absorbing polarizer (such as Melles Griot 03 FPG 007) is placed between the sample box and the camera. The camera is focused on the sample surface of the light box at a distance of ˜34 cm and the absorbing polarizer is placed ˜2.5 cm from the camera lens.

The luminance of the illuminated light box, measured with the polarizer in place and no sample optical article, was >150 cd/m2. The sample luminance is measured with the PR-650 at normal incidence to the plane of the box sample surface when the sample optical articles are placed parallel to the box sample surface, the sample articles being in general contact with the box. The relative gain is calculated by comparing this sample luminance to the luminance measured in the same fashion from the light box alone. The entire measurement was carried out in a black enclosure to eliminate stray light sources. When the relative gain of optical containing reflective polarizing elements were tested, the pass axis of the reflective polarizing element was aligned with the pass axis of the absorbing polarizer of the test system.

The diffuse reflectance of the light box was measured using a 15.25 cm (6 inch) diameter Spectralon-coated integrating sphere, a stabilized broadband halogen light source, and a power supply for the light source all supplied by Labsphere (Sutton, N.H.). The integrating sphere had three opening ports, one port for the input light (of 2.5 cm diameter), one at 90 degrees along a second axis as the detector port (of 2.5 cm diameter), and the third at 90 degrees along a third axis (i.e. orthogonal to the first two axes) as the sample port (of 5 cm diameter). A PR-650 Spectracolorimeter (same as above) was focused on the detector port at a distance of ˜38 cm. The reflective efficiency of the integrating sphere was calculated using a calibrated reflectance standard from Labsphere having ˜99% diffuse reflectance (SRT-99-050). The standard was calibrated by Labsphere and traceable to a NIST standard (SRS-99-020-REFL-51). The reflective efficiency of the integrating sphere was calculated as follows:

Sphere brightness ratio=1/(1−Rsphere*Rstandard)

The sphere brightness ratio in this case is the ratio of the luminance measured at the detector port with the reference sample covering the sample port divided by the luminance measured at the detector port with no sample covering the sample port. Knowing this brightness ratio and the reflectance of the calibrated standard (Rstandard), the reflective efficiency of the integrating sphere, Rsphere, can be calculated. This value is then used again in a similar equation to measure a sample's reflectance, in this case the PTFE light box:

Sphere brightness ratio=1/(1−Rsphere*Rsample)

Here the sphere brightness ratio is measured as the ratio of the luminance at the detector with the sample at the sample port divided by the luminance measured without the sample. Since Rsphere is known from above, it is straightforward to calculate Rsample. These reflectances were calculated at 4 nm wavelength intervals and reported as averages over the 400-700 nm wavelength range.

The relative gain, g, is calculated by comparing the sample luminance to the luminance measured in the same fashion from the light box alone, i.e.:

g=Lf/Lo

where Lf is the measured luminance with the film in place and Lo is the measured luminance without the film. The measurements were carried out in a black enclosure to eliminate stray light sources. The ‘blank’ luminance measured from the light box alone, with the absorbing polarizer of the test system in place and no samples above the light box, was approximately 275 candelas m−2. Samples were cut to a size of to 3″×5″. The long direction collinear with the transmission axis of the reflective polarizer.

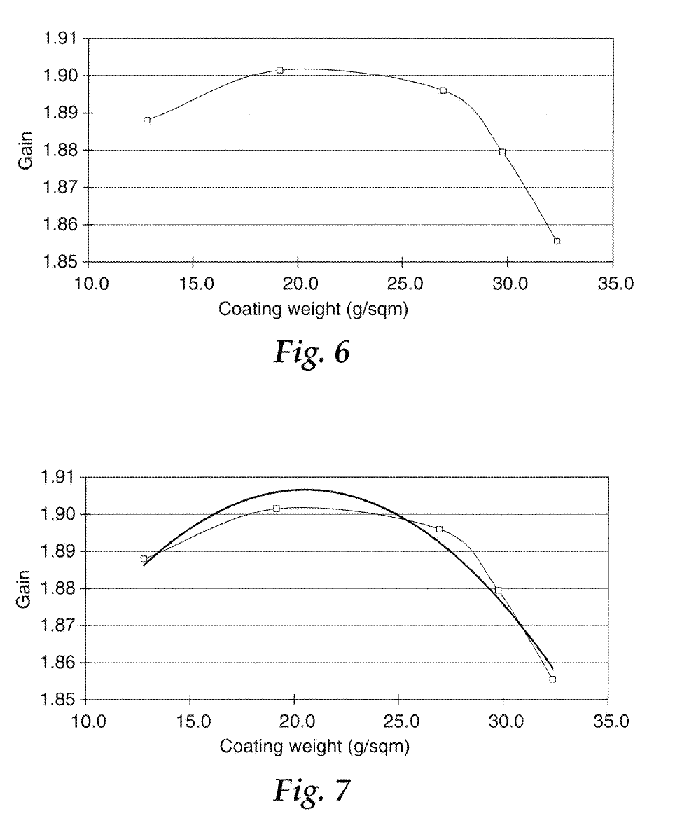

Measured relative gain data of samples 1-5 plotted as a function of coating weight is shown in FIG. 6. FIG. 7 shows the same data plot (squares) together with a non-linear functional approximation (solid line) of the following equation: y=−0.0003x̂2+0.014x+1.7629, where y=gain, x=coating weight.

### Haze/Transmittance Measurement

Haze and Transmission were measured using the standard method ASTM D1003, titled, “Standard Test Method for Haze and Luminous Transmittance of Transparent Plastics”. Samples were cut to a size of 3″×5″. Measured haze (squares) and transmittance (filled circles) data of samples 1-5 plotted as a function of coating weight is shown in FIG. 8.

### Voids Area Ratio Measurement

Depending on coating formulation and conditions, voided regions (voids) may be formed on the surface of the substrates, which contain no beads. The presence of these voids may affect the gain and other optical properties of the film. The voided area ratio is defined as the sum of the surface area of all voided regions divided by the total surface area of the sample.

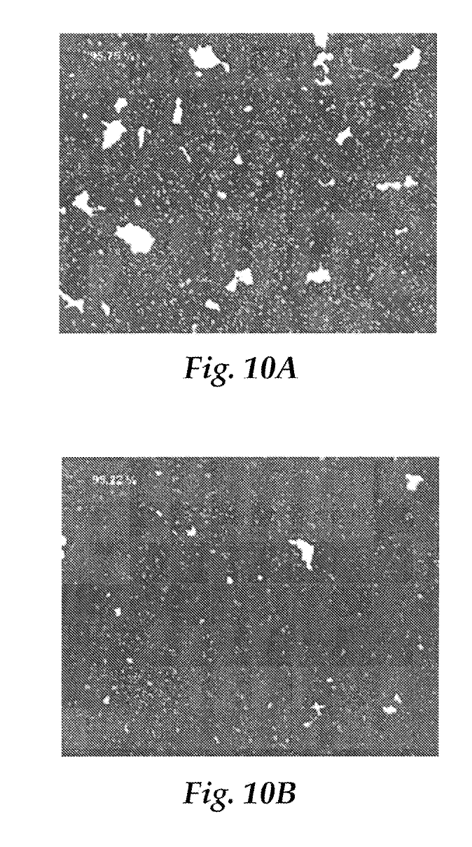

The voids area ratio measurement was completed by analyzing a sample of an optical article of the present disclosure using an optical microscope (from Zeiss Co.) in transmission mode. The sample was cut to a size of 3″×5″ and placed on the transmission stage and backlit with an intensity that is sufficient to illuminate the sample clearly using a 10× objective lens. The image of the sample was captured using image analysis software (Image Pro Plus™, Version 6 for Windows, made by Media Cybernetics, Inc., 8484 Georgia Ave., Silver Spring, Md. 20910). The Image Pro™ software compared the contrast between the bead coated areas and the voids. 5 replicate samples were tested and the individual values were averaged for the final value. This value is the average cross sectional area of the void area. The resultant voids area ratios of samples 1-5 plotted as a function of coating weight is shown in FIG. 9. FIGS. 10A and 10B show micrographs of two samples of a beaded layer according to the present disclosure with 4.25% voids area ratio and 0.78% voids area ratio, respectively, where the void areas are white. The two samples had gain of 1.90 and 1.85, respectively.

### Comparative Example 1

### PEN/coPEN Multilayer Reflective Polarizer without Skin Layers:

Optical Performance
Gain: 1.697
Haze: 1.11%
Transmittance: 50.7%

### Summary of Data

Summary of the results of the above-referenced characterizations of samples of optical articles according to the present disclosure including beaded layers (samples 1-5) are shown in Table 3:

TABLE 3

| | Coating | | | | Voids | Average |
|---|---|---|---|---|---|---|
| | weight | | | | area | area |
| Sample | (g/m2) | Gain | Transmittance | Haze | ratio % | covered % |
| 1 | 12.9 | 1.888 | 58.2 | 93.7 | 7.57 | 92.43 |
| 2 | 19.1 | 1.902 | 58.6 | 95.8 | 4.11 | 95.89 |
| 3 | 27.0 | 1.896 | 59.1 | 97.8 | 0.84 | 99.16 |
| 4 | 29.8 | 1.880 | 59.8 | 98.9 | 0.25 | 99.75 |
| 5 | 32.4 | 1.856 | 58.9 | 99.1 | 0.14 | 99.86 |

Although the optical articles and devices of the present disclosure have been described with reference to specific exemplary embodiments, those of ordinary skill in the art will readily appreciate that changes and modifications may be made thereto without departing from the spirit and scope of the present disclosure.

What is claimed is:

1. An optical article comprising:
a substrate including a reflective polarizing element preferentially reflecting light having a first polarization state and preferentially transmitting light having a second polarization state;
and
a beaded layer disposed on the substrate, the beaded layer comprising transparent binder and a plurality of transparent beads dispersed therein;
wherein the beads are present in an amount of about 100 to about 210 parts by weight per about 100 parts by weight of the binder;
wherein an average binder thickness over a linear inch is within about 60% of a median radius of the beads; and
wherein a normal angle gain of the optical article with the beaded layer is increased when compared to a normal angle gain of the same optical article but without the beaded layer.

2. The optical article of claim 1, wherein the average binder thickness over a linear inch is within about 40% of a median radius of the beads.

3. The optical article of claim 1, wherein the average binder thickness over two linear inches is within about 60% of a median radius of the beads.

4. The optical article of claim 1, wherein a mean particle diameter of the beads is about 12 to about 30 microns.

5. The optical article of claim 1, wherein the beads have a generally spherical shape.

6. The optical article of claim 1, wherein the beads are present in an amount of about 120 to about 210 parts by weight per about 100 parts by weight of the binder.

7. The optical article of claim 1, wherein the beads and binder comprise polymeric materials.

8. The optical article of claim 1, wherein the binder comprises a UV curable material, thermoplastic material, adhesive material or a combination thereof.

9. The optical article of claim 1, wherein a refractive index of the binder is matched to within about 0.1 of a refractive index of the beads.

10. The optical article of claim 1, wherein the reflective polarizing element is selected from the group consisting of: a multilayer reflective polarizer, a diffusely reflective polarizer, a wire grid reflective polarizer, and a cholesteric reflective polarizer.

11. The optical article of claim 1, wherein the optical article further comprises an additional layer.

12. The optical article of claim 11, wherein the additional layer is selected from the group consisting of: a transparent polymeric layer, an adhesive layer, a diffuser layer, a rigid plate and a matte layer.

13. The optical article of claim 1, wherein the beads cover at least about 50% per unit area of a major surface of the optical article.

14. The optical article of claim 1, wherein the normal angle gain of the optical article with the beaded layer is increased by at least about 5% when compared to the gain of the same optical article but without the beaded layer.

15. An optical article comprising:
a substrate including a reflective polarizing element preferentially reflecting light having a first polarization state and preferentially transmitting light having a second polarization state; and
a beaded layer disposed on the substrate, the beaded layer comprising transparent binder and a plurality of transparent beads dispersed therein;
wherein the beads are present in an amount of about 100 to about 210 parts by weight per about 100 parts by weight of the binder;
wherein a dry weight of the beaded layer is about 5 to about 50 g/m2; and
wherein a normal angle gain of the optical article with the beaded layer is increased when compared to a gain of the same optical article but without the beaded layer.

16. The optical article of claim 14, wherein a mean particle diameter of the beads is about 12 to about 30 microns.

17. The optical article of claim 14, wherein the beads have a generally spherical shape.

18. The optical article of claim 14, wherein the beads are present in an amount of about 120 to about 210 parts by weight per about 100 parts by weight of the binder.

19. The optical article of claim 14, wherein the beads and binder comprise polymeric materials.

20. The optical article of claim 14, wherein the binder comprises a UV curable material, thermoplastic material, adhesive material or a combination thereof.

21. The optical article of claim 14, wherein a refractive index of the binder is matched to within about 0.1 of a refractive index of the beads.

22. The optical article of claim 14, wherein the reflective polarizing element is selected from the group consisting of: a multilayer reflective polarizer, a diffusely reflective polarizer, a wire grid reflective polarizer, and a cholesteric reflective polarizer.

23. The optical article of claim 14, wherein the optical article further comprises an additional layer.

24. The optical article of claim 22, wherein the additional layer is selected from the group consisting of: a transparent polymeric layer, an adhesive layer, a diffuser layer, a rigid plate and a matte layer.

25. The optical article of claim 14, wherein the beads cover at least about 50% per unit area of a major surface of the optical article.

26. The optical article of claim 14, wherein the normal angle gain of the optical article with the beaded layer is increased by at least 5% when compared to the gain of the same optical article but without the beaded layer.

27. An optical article comprising:
a substrate including a reflective polarizing element preferentially reflecting light having a first polarization state and preferentially transmitting light having a second polarization state; and
a beaded layer disposed on the substrate, the beaded layer comprising transparent binder and a plurality of transparent beads dispersed therein;
wherein the beads are present in a volumetric amount of about 45 vol % to about 70 vol % of the coating;
wherein an average binder thickness over a linear inch is within about 60% of a median radius of the beads; and
wherein a normal angle gain of the optical article with the beaded layer is increased when compared to a gain of the same optical article but without the beaded layer.

28. The optical article of claim 27, wherein a mean particle diameter of the beads is about 12 to about 30 microns.

29. The optical article of claim 27, wherein the beads have a generally spherical shape.

30. The optical article of claim 27, wherein the beads are present in an amount of about 120 to about 210 parts by weight per about 100 parts by weight of the binder.

31. The optical article of claim 27, wherein the beads and binder comprise polymeric materials.

32. The optical article of claim 27, wherein the binder comprises a UV curable material, thermoplastic material, adhesive material or a combination thereof.

33. The optical article of claim 27, wherein a refractive index of the binder is matched to within about 0.1 of a refractive index of the beads.

34. The optical article of claim 27, wherein the reflective polarizing element is selected from the group consisting of: a multilayer reflective polarizer, a diffusely reflective polarizer, a wire grid reflective polarizer, and a cholesteric reflective polarizer.

35. The optical article of claim 27, wherein the optical article further comprises an additional layer.

36. The optical article of claim 35, wherein the additional layer is selected from the group consisting of: a transparent polymeric layer, an adhesive layer, a diffuser layer, a rigid plate and a matte layer.

37. The optical article of claim 27, wherein the beads cover at least about 50% per unit area of a major surface of the optical article.

38. The optical article of claim 27, wherein the normal angle gain of the optical article with the beaded layer is increased by at least about 5% when compared to the gain of the same optical article but without the beaded layer.
